(19) United States
(12) Patent Application Publication
(10) Pub. No.: US 2014/0380025 A1
(43) Pub. Date: Dec. 25, 2014

(54) MANAGEMENT OF HARDWARE ACCELERATOR CONFIGURATIONS IN A PROCESSOR CHIP

(71) Applicant: EMPIRE TECHNOLOGY DEVELOPMENT LLC, Wilmington, DE (US)

(72) Inventor: Ezekiel Kruglick, Poway, CA (US)

(21) Appl. No.: 14/123,231

(22) PCT Filed: Jan. 23, 2013
(86) PCT No.: PCT/US2013/022609

§ 371 Date: Dec. 2, 2013

(51) Int. Cl. G06F 9/30

(52) U.S. Cl. CPC G06F 9/30007
USPC 712/220

(57) ABSTRACT

Techniques described herein generally include methods for the management of hardware accelerator images in a processor chip that includes one or more programmable logic circuits. Hardware accelerator images may be optimized by swapping out which hardware accelerator images are implemented in the one or more programmable logic circuits. The hardware accelerator images may be chosen from a library of accelerator programs downloaded to a device associated with the processor chip. Furthermore, the specific hardware accelerator images that are implemented in the one or more programmable logic circuits at a particular time may be selected based on which combination of accelerator images best enhances performance and power usage of the processor chip.

### BACKGROUND

Unless otherwise indicated herein, the approaches described in this section are not prior art to the claims in this application and are not admitted to be prior art by inclusion in this section.

In keeping with Moore's Law, the number of transistors that can be practicably incorporated into an integrated circuit has doubled approximately every two years. This trend has continued for more than half a century and is expected to continue until at least 2015 or 2020. However, simply adding more transistors to a single-threaded processor no longer produces a significantly faster processor. Instead, increased system performance has been attained by integrating multiple processor cores on a single chip to create a chip multiprocessor and sharing processes among the multiple processor cores of the chip multiprocessor. But even this approach has limitations.

With each successive process generation, the percentage of a chip that can actively switch drops exponentially due to limitations on threshold voltage scaling related to power use and heat dissipation. Thus, in a few process generations, chip multiprocessors will only be able to make use of a small fraction of a silicon die at full frequency at once. This “utilization wall” will prevent massively multi-core processors from effectively employing more than a small subset of cores at once, which undermines the utility of building high core-count processors. In addition, the expanded use of mobile computing devices makes the execution of complex code at minimum power highly desirable in multi-core processors.

Hardware accelerators offer the best solution to meet the demand for maximum performance using minimum power. A hardware accelerator generally includes separate logic circuits from the central processing unit of a computing device, and is used to perform certain functions faster than is possible in software running on a general-purpose central processing unit. To that end, hardware accelerators may be programmable to allow specialization to a particular task or function, and may consist of a combination of software, hardware, and firmware. Typically, hardware accelerators are designed for computationally intensive software code, and can vary from a small functional unit, such as a floating-point accelerator, to a large functional block, such as a graphics processing unit.

### SUMMARY

In accordance with at least some embodiments of the present disclosure, a method for implementing an accelerator program in a processor having at least one programmable logic circuit is generally described. Example methods described herein may include monitoring a use state of the processor as instructions of an application are being executed by the processor. Based on the use state, an accelerator program stored in a library associated with the processor is selected. One of the at least one programmable logic circuits is programmed with the selected accelerator program to execute at least some of the instructions of the application.

In accordance with at least some embodiments of the present disclosure, a method for programming a programmable logic circuit in a processor chip is generally described. Example methods described herein may include monitoring use of a programmable logic circuit when the programmable logic circuit in the processor chip is programmed with a first accelerator program. Some example methods may include recording data associated with the use of the programmable logic circuit when the programmable logic circuit is programmed with the first accelerator program. In some examples, a second accelerator program based on the recorded data is selected and the second selected accelerator program is retrieved from a library associated with the processor chip. And in some example methods, the programmable logic circuit in the processor chip is programmed with the second accelerator program.

In accordance with at least some embodiments of the present disclosure, a method for programming a programmable logic circuit in a processor chip is generally described. Example methods described herein may include running an application on the processor and determining a first power cost associated with 1) reprogramming the programmable logic circuit with an accelerator program configured for running a portion of the application and 2) running the application with the reprogrammed logic circuit. Some example methods may include determining a second power cost associated with running the application without using the reprogrammed logic circuit and comparing the first power cost to the second power cost. In some examples, based on the comparison, one of the at least one programmable logic circuits may be programmed with the accelerator program configured for running a portion of the application.

In accordance with at least some embodiments of the present disclosure, a processor having one or more programmable logic circuits, a memory, and a strategy module is described. The strategy module may be configured to store in the memory one or more programs for the one or more programmable logic circuits, monitor usage of the one or more programmable logic circuits, and, based on monitored usage, program the one or more programmable logic circuits with the stored one or more programs for the one or more programmable logic circuits.

In accordance with at least some embodiments of the present disclosure, a method for programming a programmable logic circuit in a processor chip is generally described. Example methods described herein may include storing in the memory one or more programs for the one or more programmable logic circuits, monitoring usage of the one or more programmable logic circuits, and, based on monitored usage, programming the one or more programmable logic circuits with the stored one or more programs for the one or more programmable logic circuits.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the present disclosure and are, therefore, not to be considered limiting of its scope. The present disclosure will be described with additional specificity and detail through use of the accompanying drawings.

FIG. 1 shows a block diagram of an example embodiment of a processor chip;

FIG. 2 sets forth a flowchart summarizing an example method for implementing an accelerator program in a processor chip having at least one programmable logic circuit;

FIG. 3 sets forth a flowchart summarizing an example method for programming a programmable logic circuit in a processor chip;

FIG. 4 sets forth a flowchart summarizing an example method for programming one or more programmable logic circuits in a processor chip;

FIG. 5 is a block diagram of an illustrative embodiment of a computer program product for implementing a method of managing programmable logic circuits in a processor chip; and

FIG. 6 is a block diagram illustrating an example computing device that is arranged for managing programmable logic circuits in a processor chip, all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

As noted above, hardware accelerators are well-suited for providing high-speed processing with reduced power use. Currently, hardware accelerators may be implemented as either fixed hardware, such as application-specific integrated circuits (ASICs), or may be built on top of programmable logic circuits, such as field-programmable gate array chips (FPGAs), which can be configured in the field as an accelerator for a particular software application. In some examples, mixed implementations such as patchable ASICs may be employed. Implementing hardware acceleration in fixed hardware has the disadvantages of longer and more expensive design cycles, the risk of expensive product recalls if errors are found in the fixed silicon implementation, and the inability to upgrade fixed silicon functions in deployed products when newly developed features are added to any applications for which the hardware accelerator is designed. Consequently, hardware accelerators built on programmable logic circuits that can be reconfigured with architecture associated with a particular application are highly desirable.

Typically, a programmable logic circuit in a computing device can be configured with a desired application-specific architecture, or hardware image, via an accelerator program associated with a particular application. Namely, the accelerator program is used to configure the programmable logic circuit with an accelerator hardware image prior to or during the computing device running the application, for example when said application is first installed onto the computing device. With the programmable logic circuit configured in this way, subsequent processing of the application by the computing device can be performed at an accelerated rate and with reduced power consumption. However, given the large number of applications that may benefit from such specially tailored hardware acceleration, and given the limited number of programmable logic circuits available in any computing device, the number of accelerator images that can be utilized by a computing device can easily exceed the number of available programmable logic circuits.

Example embodiments of the present disclosure relate to hardware accelerators, and more particularly to a method for managing hardware accelerator configurations in a processor chip. Specifically, in a processor chip that includes one or more programmable logic circuits, the management of hardware accelerators may be optimized by selecting which hardware accelerator images are implemented in the one or more programmable logic circuits. The hardware accelerator images may be chosen from a library of accelerator programs downloaded to a device associated with the processor chip. Furthermore, the specific hardware accelerator images that are implemented in the one or more programmable logic circuits at a particular time may be selected based on which combination of accelerator images best enhances performance and/or power usage of the processor chip at the time. Various criteria may be used in the selection process.

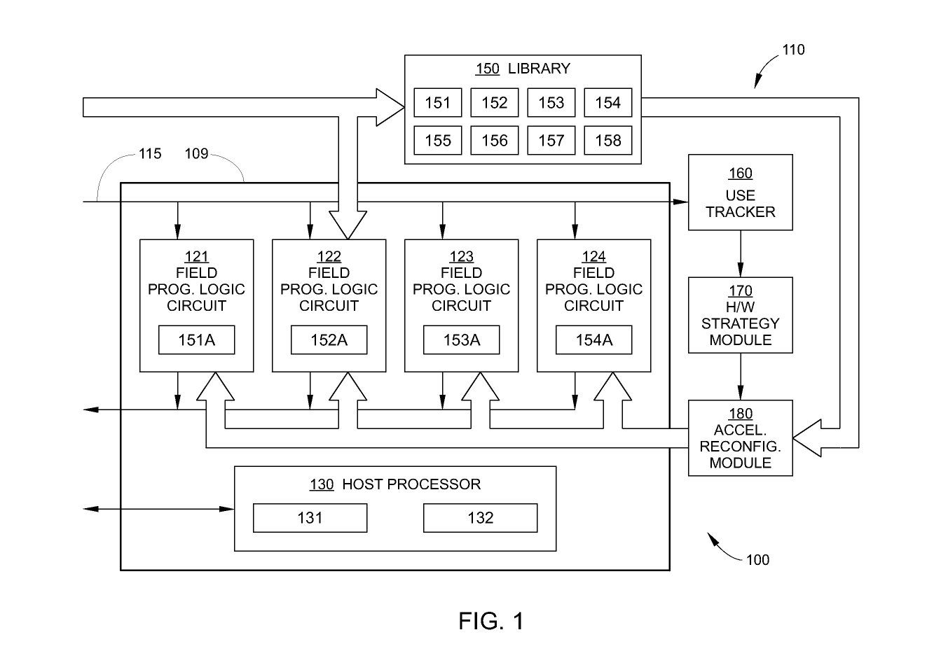

FIG. 1 shows a block diagram of an example embodiment of a processor chip 100, arranged in accordance with at least some embodiments of the present disclosure. Processor chip 100 may include one or more processor cores. Processor chip 100 may be formed on a single integrated circuit die 109 and may be configured to carry out one or more processing tasks in parallel. Processor chip 100 may include multiple field-programmable logic circuits 121-124 formed on integrated circuit die 109 that can be configured as hardware accelerators for the processing of one or more applications run on processor chip 100. In some embodiments, processor chip 100 also includes a host processor 130 formed on integrated circuit die 109. Host processor 130 may be configured as a central processing unit (CPU) or other general purpose processor and may include an instruction buffer 131 and/or a data buffer 132, which are sometimes referred to together as “L1 cache.”

Generally, processor chip 100 may be included as part of a host computing device (not shown in FIG. 1). In some embodiments, such a computing device may be a mobile computing device, such as a cellular phone, electronic tablet, digital personal assistant, laptop computer, and the like. In other embodiments, the host computing device that includes processor chip 100 may make up a part of a cloud computing infrastructure configured to provide Internet-based computing. In yet other embodiments, the host computing device that includes processor chip 100 may be a conventional desktop computer or an appliance or other electronic device that is integrated into a ubiquitous computing environment.

Field-programmable logic circuits 121-124 are integrated logic circuits that are designed to be configured by a user or designer after manufacturing and are therefore “field-programmable.” In some embodiments, one or more of field-programmable logic circuits 121-124 comprise a field-programmable gate array (FPGA), which can be used to implement any logical function that can be performed by an application-specific integrated circuit (ASIC). In other embodiments, field-programmable logic circuits 121-124 may comprise complex programmable logic devices (CPLDs) or patchable ASICs. Unlike conventional ASICs, field programmable logic circuits 121-124 can be re-configured and/or have functionality updated after manufacturing. Consequently, each of field-programmable logic circuits 121-124 can be reprogrammed as desired during operation with a hardware accelerator image and function as a hardware accelerator for a specific application. To that end, one or more of field-programmable logic circuits 121-124 may include programmable logic components referred to as “logic blocks” and a hierarchy of reconfigurable interconnects that allow the logical blocks to be inter-wired in different configurations. Such logic blocks can be configured to perform complex combinational functions or simple logical functions, such as AND and XOR. In some embodiments, one or more of field-programmable logical circuits 121-124 may also include memory elements, which may comprise simple flip-flops and/or more complete blocks of memory, or other useful previously manufactured analog or digital blocks.

In the embodiment illustrated in FIG. 1, field-programmable logic circuits 121-124 are programmed with accelerator programs 151-154 respectively, and function as hardware accelerators 151A-154A, respectively. However, field-programmable logic circuits 121-124 may be programmed with any combination of hardware accelerators available from accelerator programs 151-158 stored in library 150 without exceeding the scope of the present disclosure. Library 150, hardware accelerators 151A-154A and accelerator programs 151-158 are described below. Field-programmable logic circuit 121 (or field-programmable logic circuits 122-124) can be programmed to function as hardware accelerator 151A using accelerator program 151, either when accelerator program 151 is first received by processor chip 100 or at any time that it is desired that one of field-programmable logic circuits 121-124 be programmed to function as hardware accelerator 151A. In a similar fashion, any of field-programmable logic circuits 121-124 can be programmed to function as hardware accelerator 152A using accelerator program 152; any of field-programmable logic circuits 121-124 can be programmed to function as hardware accelerator 153A using accelerator program 153; and any of field-programmable logic circuits 121-124 can be programmed to function as hardware accelerator 154A using accelerator program 154.

In the embodiment illustrated in FIG. 1, an accelerator program is shown being received by processor chip 100. The received accelerator program may be saved in library 150 and may also be used to program field-programmable logic circuit 122 with a particular hardware accelerator image. In other embodiments, the received accelerator program may program one of field-programmable logic circuits 121-124 with the hardware accelerator image of interest, and said hardware accelerator image may be subsequently extracted from the programmed field-programmable logic circuit and saved as an accelerator program in library 150.

In the embodiment illustrated in FIG. 1, processor chip 100 is depicted with four field-programmable logic circuits 121-124. In other embodiments, processor chip 100 may include more than or fewer than four field-programmable logic circuits. In some embodiments, processor chip 100 may be configured as a high core-count chip multiprocessor, with a plurality of conventional processor cores instead of a single host processor like host processor 130. In some embodiments, field-programmable logic circuits 121-124 may be substantially similar in size, complexity, memory element make-up, and physical circuit configuration prior to programming. In other embodiments, field-programmable logic circuits 121-124 may be heterogeneous in physical configuration. In such embodiments, one or more of field-programmable logic circuits 121-124 may be better suited to be programmed as a hardware accelerator for a particular application run on processor chip 100 than other of field-programmable logic circuits 121-124. In some embodiments, two or more of field-programmable logic circuits 121-124 may be physically realized within a single larger circuit array.

FIG. 1 also depicts components of an optimization system 110 that can facilitate implementation of one or more embodiments of the present disclosure in conjunction with processor chip 100. Optimization system 110 may include one or more of a library 150, a usage tracker 160, a hardware strategy module 170, and an accelerator reconfigure module 180, and may be configured to manage the selection and programming of field-programmable logic circuits 121-124 as hardware accelerators during operation of processor chip 100. One or more of the elements of optimization system 110 may be implemented as elements formed on integrated circuit die 109, or may reside off-chip. In the embodiment illustrated in FIG. 1, elements of optimization system 110 are depicted as off-chip elements.

Library 150 stores accelerator programs 151-158 that are each associated with either software applications installed on the host computing device that includes processor chip 100 or web applications that are not installed on processor chip 100 but are run on processor chip 100. Specifically, accelerator programs 151-158 are configured to program a suitable field-programmable logic circuit in processor chip 100 with hardware accelerators 151A-158A, respectively. In some embodiments, accelerator programs 151-158 stored in library 150 include accelerator programs that are downloaded when associated software applications are initially installed on said host computing device. In addition, in some embodiments, accelerator programs 151-158 include accelerator programs that are stored in library 150 during the manufacture of processor chip 100. Library 150 may include on-chip memory, off-chip memory, or a combination of each. Library 150 may be implemented on-chip as one or more non-volatile memory blocks formed on integrated circuit die 109, such as flash memory or phase-change memory. Library 150 may be implemented as off-chip memory as a portion of a hard disk drive, flash memory, or other non-volatile storage.

In some embodiments, accelerator programs 151-158 can be added to library 150 when such configuration programming may be initially received by processor chip 100. Generally, FPGAs like field-programmable logic circuits 121-124 are not configured in a way that allows programming code, such as hardware accelerators 151A-158A, to be read out. Consequently, in some embodiments, processor chip 100 can be advantageously configured to store an accelerator program in library 150 when initially received for programming, thereby facilitating the programming of field-programmable logic circuits 121-124 with any suitable hardware accelerator that has been used previously by processor chip 100.

Usage tracker 160 monitors and records the use of hardware accelerators that are programmed into field-programmable logic circuits 121-124 as well as various use states of processor chip 100 associated with the use of said hardware accelerators. In this way, hardware strategy module 170 (described below), can determine strategies that prioritize which of accelerator programs are programmed into field-programmable logic circuits 121-124 for optimal power utilization and/or processing performance. For hardware strategy module 170 to implement strategies for successfully managing hardware accelerators in processor chip 100, usage tracker 160 provides pertinent information regarding how processor chip 100 is used and when. Thus, to provide hardware strategy module 170 with information so that power use in a mobile computing device that includes processor chip 100 is minimized, usage tracker 160 may monitor a variety of use states of processor chip 100 and times when particular applications are run on processor chip 100. For example, usage tracker 160 may track when and where processor chip 100 is typically coupled to an external power source, where charging status may be provided by an operating system associated with processor chip 100. Usage tracker 160 may receive time of day information from the operating system associated with processor chip 100 and location information from a GPS device associated with processor chip 100. Other information that usage tracker 160 may track may include when and at what physical location particular applications are run on processor chip 100; the typical time elapsed (if any) before a particular application is closed; the typical location (if any) at which a particular application is opened or closed; the power cost associated with programming one of field-programmable logic circuits 121-124 with an accelerator program associated with a specific application; order and relationship of multiple application usage; and power usage of a particular application with and without hardware acceleration, among others. Furthermore, usage tracker 160 may also monitor and record information that can be provided to hardware strategy module 170 to optimize performance of processor chip 100 for various combinations of simultaneously running applications.

Hardware strategy module 170 may be implemented as hardware (e.g., an ASIC or FPGA), software, or firmware, and selects which of field-programmable logic circuits 121-124 are programmed with which accelerator programs available from library 150. As noted above, selection strategies may be based on power conservation, computing performance, and a combination of both. Different selection strategies for programming hardware accelerators may be implemented by hardware strategy module 170 in different situations. In some embodiments, selection strategies may be based on historical usage patterns of the different programmable circuits and/or applications, such as when recreation-oriented applications vs. business or communication-oriented applications are utilized by a user. For example, weekends, evenings, and work hours may all have different historical usage patterns, and hardware strategy module 170 may base selection strategies for hardware accelerators on such information. Basing selection strategies on such planned timing may allow the system to engage in reprogramming while attached to charging power, for a mobile device. When processor chip 100 is part of a data center or server computer, trends may follow time zones for various applications related to different businesses. An alternate strategy in either environment may involve predicting application order, such as predicting that social media posts often result shortly after a newsreader is used or the order in which a datacenter process uses different data analysis tools.

For example, in an embodiment in which a mobile device that includes processor chip 100 is not coupled to a power source external to the mobile device (for example, a wall charger or a wireless charging station), power conservation may be the primary strategy implemented by hardware strategy module 170. When more applications are running on processor chip 100 than the number of suitable field-programmable logic circuits 121-124, applications running on processor chip 100 that use the most power may be the applications selected for hardware acceleration. In some embodiments, hardware strategy module 170 may first estimate potential energy savings associated with implementing hardware acceleration for any particular application of interest prior to actually programming one of field-programmable logic circuits 121-124 with a suitable accelerator program. If the energy cost of programming one of field-programmable logic circuits 121-124 with the desired hardware accelerator exceeds the estimated energy cost of running the application of interest without hardware acceleration, hardware strategy module 170 may opt to not implement hardware acceleration for said application. The estimated energy cost of running said application without hardware acceleration may be based on an assumed usage typical for the application for a typical duration of use for the application.

In another embodiment in which a mobile device includes processor chip 100, hardware strategy module 170 may implement strategies tailored for reducing power use in the mobile device prior to disconnecting processor chip 100 from the external power source. Because programming some types of field-programmable logic circuits is relatively power intensive, hardware strategy module 170 may predict when processor chip 100 will be disconnected from an external power source based on information collected by usage tracker 160. Based on this predicted disconnect time, hardware strategy module may program one or more of field-programmable logic circuits 121-124 with the most likely to be used hardware accelerators prior to the predicted disconnect time. For example, information collected by usage tracker 160 may indicate that processor chip 100 is typically disconnected shortly after a morning alarm provided by the host computing device for processor chip 100 goes off. Consequently, hardware strategy module 170 may program one or more of field-programmable logic circuits 121-124 prior to the predicted alarm time with suitable hardware accelerator configurations. In some embodiments, the suitable hardware configurations are associated with applications most likely to be used, based on use history of processor chip 100, within a predetermined time period after external power is removed. In some embodiments, hardware strategy module 170 may program one or more of field-programmable logic circuits 121-124 based on the necessity of a processor reset after programming the one or more programmable logic circuits 121-124 with a particular accelerator program.

In some embodiments, for example when power conservation is a lower priority, hardware strategy module 170 may implement strategies for improving processing performance of processor chip 100. For example, the field-programmable logic circuits 121-124 may be programmed with hardware accelerators that provide the fastest processing rather than the lowest power consumption. Such a strategy may be based on information collected by usage tracker 160 during operation of processor chip 100, such as frequency of use of different applications, which applications are typically run in conjunction with each other on processor chip 100, etc. It is noted that strategies for selecting what hardware accelerators are programmed into field-programmable logic circuits 121-124 may be implemented based on other factors as well without exceeding the scope of the present disclosure.

Accelerator reconfigure module 180 fetches accelerator programs from selected by hardware strategy module 170 from library 150. Accelerator reconfigure module 180 may also facilitate the programming of hardware accelerators into the desired field-programmable logic circuits 121-124 with the selected accelerator programs.

Usage tracker 160, hardware strategy module 170, and accelerator reconfigure module 180 may be implemented as software constructs, such as a module of an operating system that is associated with processor chip 100 and/or with the host computing device that includes processor chip 100. Alternatively, usage tracker 160, hardware strategy module 170, and/or accelerator reconfigure module 180 may be implemented as hardware, such as one or more ASICs, to perform the above-described functions. In yet other embodiments, usage tracker 160, hardware strategy module 170, and/or accelerator reconfigure module 180 may be implemented as firmware associated with processor chip 100 and/or as a combination of hardware and software.

Library 150 may be implemented within a memory of processor chip 100. Alternatively, library 150 may be implemented off-chip in a separate memory system.

In operation, processor chip 100 receives one or more accelerator programs, such as accelerator programs 151-158, which are programmed into available field-programmable logic circuits 121-124 and are also stored in library 150. Each of the one or more accelerator programs may be received in conjunction with an associated application being loaded onto the host computing device that includes processor chip 100. Alternatively, the one or more accelerator programs may be received during the initial setup of processor chip 100. In yet other embodiments, accelerator programs 151-158 may be received as downloads to processor chip 100 when accelerator programs already available in library 150 are updated. During operation of processor chip 100, usage tracker 160 monitors and records information as described above, and hardware strategy module 170 implements selection strategies for programming field-programmable logic circuits 121-124 based on said information. In some embodiments, usage tracker 160 monitors field-programmable logic circuits 121-124 via inputs 115. Accelerator reconfigure module 180 then fetches the desired accelerator programs and facilitates the programming thereof into the desired field-programmable logic circuits 121-124.

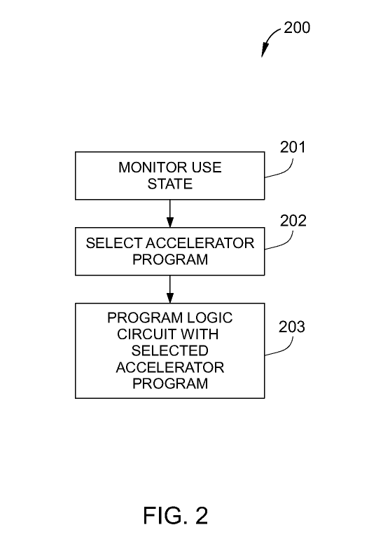

FIG. 2 sets forth a flowchart summarizing an example method 200 for implementing an accelerator program in a processor chip having at least one programmable logic circuit, in accordance with at least some embodiments of the present disclosure. Method 200 may include one or more operations, functions, or actions as illustrated by one or more of blocks 201-203. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation.

For ease of description, method 200 is described in terms of a processor chip substantially similar to processor chip 100 and a hardware accelerator management system substantially similar to optimization system 110 in FIG. 1. One of skill in the art will appreciate that method 200 may be performed by other configurations of processor chips and still fall within the scope of the present disclosure. Prior to the first operation of method 200, one or more applications and associated accelerator programs 151-158 may be loaded onto the host computing device that includes processor chip 100. In addition, one or more of the accelerator programs 151-158 may be used to program one or more of field-programmable logic circuits 121-124.

Method 200 may begin in block 201 “monitor use state.” Block 201 may be followed by block 202 “select accelerator program,” and block 202 may be followed by block 203 “program logic circuit with selected accelerator program.”

In block 201, usage tracker 160 of optimization system 110 monitors one or more use states of processor chip 100. Generally, block 201 takes place during normal operation of processor chip 100. Various use states of processor chip 100 that may be monitored are described above in conjunction with FIG. 1, and include availability of an external power source, time of use and location of use associated with particular applications run on processor chip 100, and what applications are typically run concurrently on processor chip 100.

In block 202, hardware strategy module 170 selects an appropriate accelerator program from library 150 based on the information collected in block 201. The strategy implemented to make such a selection may be based on optimal power consumption, processing speed, or a combination of both. A large variety of factors may contribute to the selection made in block 202, and are outlined in greater detail above in conjunction with FIG. 1.

In block 203, accelerator reconfigure module 180 fetches one or more of accelerator programs 151-158 that correspond to the accelerator programs selected in block 202. In some embodiments, accelerator reconfigure module 180 may also facilitate the programming of one or more of field-programmable logic circuits 121-124 with the accelerator programs selected in block 202. In some embodiments, one or more field-programmable logic circuits 121-124 are reprogrammed in block 203 from a preexisting architecture to a new architecture using the fetched accelerator program to facilitate improved power consumption and/or processing speed in processor chip 100, given the current user state of and applications running on processor chip 100.

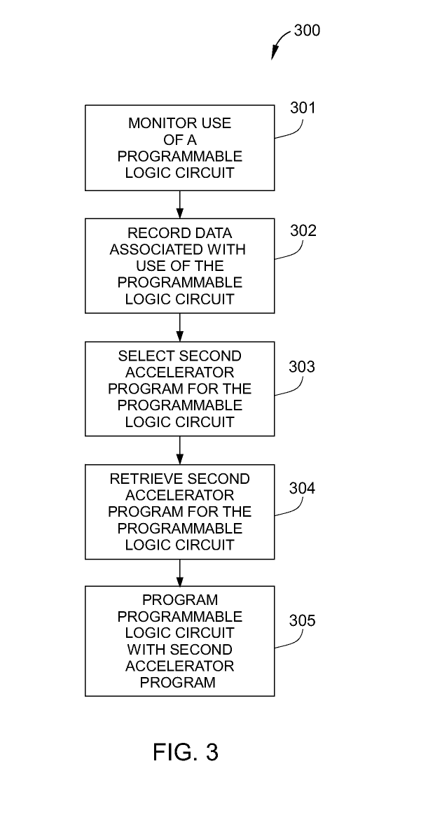

FIG. 3 sets forth a flowchart summarizing an example method 300 for programming a programmable logic circuit in a processor chip, in accordance with at least some embodiments of the present disclosure. Method 300 may include one or more operations, functions or actions as illustrated by one or more of blocks 301-305. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation.

For ease of description, method 300 is described in terms of a processor chip substantially similar to processor chip 100 and a hardware accelerator management system substantially similar to optimization system 110 in FIG. 1. One of skill in the art will appreciate that method 300 may be performed by other configurations of processor chips and still fall within the scope of the present disclosure. Prior to the first operation of method 300, one or more applications are run by the host computing device that includes processor chip 100. The applications may be loaded onto the host computing device or may be web applications that are not loaded onto the host computing device. Various performance parameters are then measured for processor chip 100 when running the one or more applications with and without suitable hardware acceleration. For example, in some embodiments, performance of processor chip 100 is monitored with respect to each of the one or more applications, first with one of field-programmable logic circuits 121-124 programmed with an associated accelerator program and then with none of field-programmable logic circuits 121-124 programmed with an associated accelerator program. In some embodiments, a power cost associated with programming one of field-programmable logic circuits 121-124 with each of accelerator programs 151-158 may also be determined prior to method 300.

Method 300 may begin in block 301 “monitor use of a programmable logic circuit.” Block 301 may be followed by block 302 “record data associated with use of the programmable logic circuit,” block 302 may be followed by block 303 “select second accelerator program for the programmable logic circuit,” block 303 may be followed by block 304 “retrieve second accelerator program for the programmable logic circuit,” and block 304 may be followed by block 305 “program programmable logic circuit with second accelerator program.”

In block 301, usage tracker 160 of optimization system 110 monitors the use of one of field-programmable logic circuits 121-124 that is programmed with an accelerator program associated with an application currently running on processor chip 100. Generally, block 301 takes place during normal operation of processor chip 100. Various performance metrics of processor chip 100 may be monitored in block 301, including power usage and processing speed of processor chip 100. In addition, other use state information associated with processor chip 100 may be monitored as well, including time of day, availability of external power, location of processor chip 100 (when processor chip 100 is included in a computing device that further includes GPS capability), and what other applications are currently on processor chip 100, among others.

In block 302, usage tracker 160 records data associated with the use of the programmable logic circuit monitored in block 301. In some embodiments the recorded data are stored on-chip. In other embodiments, the recorded data are stored off-chip, such as in flash memory or on a hard disk drive associated with processor chip 100.

In block 303, hardware strategy module 170 selects a second accelerator program available in library 150 based on the information collected in block 301. The strategy implemented to make such a selection may be based on power consumption, processing speed, or a combination of both. Generally, the accelerator program selected in block 303, when programmed into one of field-programmable logic circuits 121-124, may reduce power consumption and/or increase processing speed of processor chip 100.

In block 304, accelerator reconfigure module 180 fetches an accelerator program selected in block 303 from library 150. For example, the accelerator program fetched in block 304 may be one of accelerator programs 151-158. In embodiments in which the host computing device that includes processor chip 100 is part of a cloud computing infrastructure, processor chip 100 may be associated with a data center, and access to accelerator programs may be restricted to use by a specific user.

In block 305, the accelerator program fetched in block 304 by accelerator reconfigure module 180 may be used to program one of field-programmable logic circuits 121-124. It is noted that the field-programmable logic circuit is generally programmed with a hardware accelerator architecture prior to method 300 and therefore is being reprogrammed with a different hardware accelerator architecture in block 305. Thus, even though the hardware accelerator being replaced in block 305 is associated with an application that may be currently running on processor chip 100, said hardware accelerator may be overwritten with a different hardware accelerator architecture in order to improve energy efficiency and/or processing speed of processor chip 100. In some embodiments, the specific field-programmable logic circuit that is reprogrammed in block 305 is also selected by hardware strategy module 170.

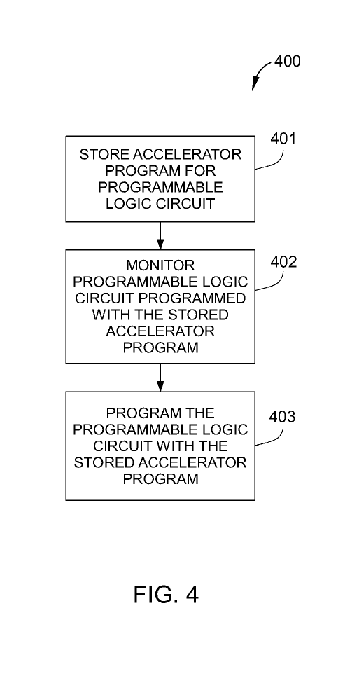

FIG. 4 sets forth a flowchart summarizing an example method 400 for programming one or more programmable logic circuits in a processor chip, in accordance with at least some embodiments of the present disclosure. Method 400 may include one or more operations, functions or actions as illustrated by one or more of blocks 401-403. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation.

For ease of description, method 400 is described in terms of a processor chip substantially similar to processor chip 100 and a hardware accelerator management system substantially similar to optimization system 110 in FIG. 1. One of skill in the art will appreciate that method 400 may be performed by other configurations of processor chips and still fall within the scope of the present disclosure.

Method 400 may begin in block 401 “store accelerator program for programmable logic circuit.” Block 401 may be followed by block 402 “monitor programmable logic circuit programmed with the stored accelerator program,” and block 402 may be followed by block 403 “program the programmable logic circuit with the stored accelerator program.”

In block 401, optimization system 110 stores one or more accelerator programs suitable for use with one or more of field-programmable logic circuits 121-124, such as accelerator programs 151-158, in library 150. In some embodiments, accelerator programs 151-158 are stored in library 150 when initially downloaded to a host computing device. In other embodiments, the downloaded accelerator program may be used to program one of field-programmable logic circuits 121-124 with the hardware accelerator image of interest, and said hardware accelerator image may be subsequently extracted from the programmed field-programmable logic circuit and saved as an accelerator program in library 150.

In block 402, optimization system 110, via usage tracker 160, can monitor usage of one or more of field-programmable logic circuits 121-124 during operation of processor chip 100. Some example of the monitoring include, without limitation, (i) monitoring amount of time a given field programmable logic circuit is in used, when configured with a first accelerator program, (ii) correlating the use state of host processor 130 of FIG. 1 (e.g., executing a first application A) with usage of one or more of the field programmable logic circuits, and (iii) identifying the field programmable logic circuit to reprogram based on reprogramming cost (e.g., power), historical usage, the program it is currently configured for, etc.

In block 403, optimization system 110 can select and program one or more of field-programmable logic circuits 121-124 with one of the accelerator programs stored in library 150 in block 401. The selection made in block 403 can be based on the usage of field-programmable logic circuits 121-124 monitored in block 402, and may be performed by hardware strategy module 170. Various selection criteria and strategies for hardware strategy module 170 are described above in conjunction with FIG. 1.

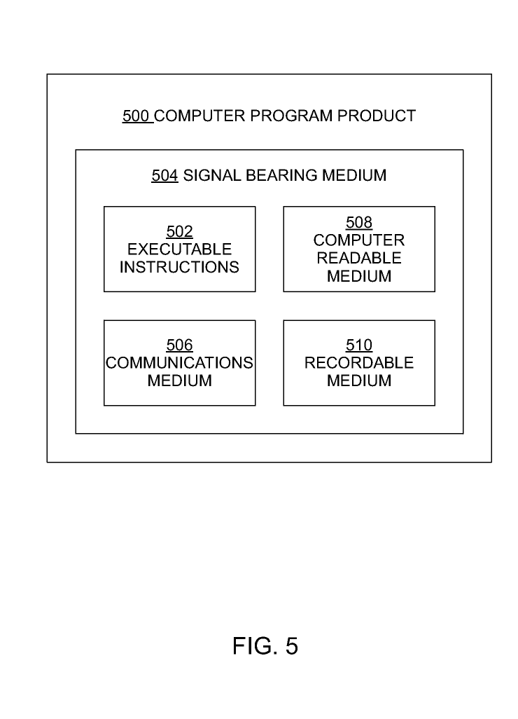

FIG. 5 is a block diagram of an illustrative embodiment of a computer program product 500 for implementing a method of managing programmable logic circuits in a processor chip, in accordance with at least some embodiments of the present disclosure. Computer program product 500 may include a signal bearing medium 504. Signal bearing medium 504 may include one or more sets of executable instructions 502 that, when executed by, for example, a processor of a computing device, may provide at least the functionality described above with respect to FIGS. 2, 3, and 4.

In some implementations, signal bearing medium 504 may encompass a non-transitory computer readable medium 508, such as, but not limited to, a hard disk drive, a Compact Disc (CD), a Digital Video Disk (DVD), a digital tape, flash memory, etc. In some implementations, signal bearing medium 504 may encompass a recordable medium 510, such as, but not limited to, memory, read/write (R/W) CDs, R/W DVDs, etc. In some implementations, signal bearing medium 504 may encompass a communications medium 506, such as, but not limited to, a digital and/or an analog communication medium (e.g., a fiber optic cable, a waveguide, a wired communications link, a wireless communication link, etc.). Computer program product 500 may be recorded on non-transitory computer readable medium 508 or another similar recordable medium 510.

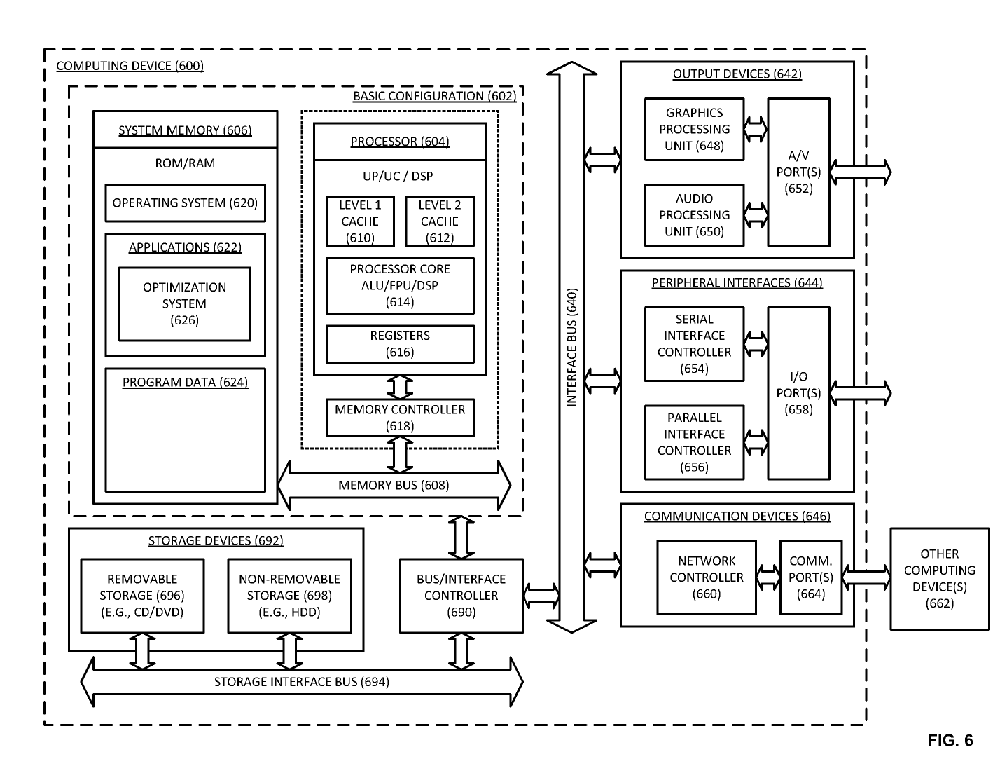

FIG. 6 is a block diagram illustrating an example computing device 600 that is arranged for managing programmable logic circuits in a processor chip, in accordance with at least some embodiments of the present disclosure. In a very basic configuration 602, computing device 600 typically includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. Processor 604 may include programmable logic circuits, such as, without limitation, FPGA, patchable ASIC, CPLD, and others. Processor 604 may be similar to processor chip 100 of FIG. 1. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624. Application 622 may include optimization system 626, such as optimization system 110 of FIG. 1, arranged to perform the functions such as those described with respect to method 200 of FIG. 2, method 300 of FIG. 3, and/or method 400 of FIG. 4. Program data 624 may include data that may be useful for operation with optimization system 626 as is described herein. In some embodiments, application 622 may be arranged to operate with program data 624 on operating system 620. This described basic configuration 602 is illustrated in FIG. 6 by those components within the inner dashed line.

Computing device 600 may have additional features or functionality, and additional interfaces to facilitate communications between basic configuration 602 and any required devices and interfaces. For example, a bus/interface controller 690 may be used to facilitate communications between basic configuration 602 and one or more data storage devices 692 via a storage interface bus 694. Data storage devices 692 may be removable storage devices 696, non-removable storage devices 698, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 696 and non-removable storage devices 698 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link, such as, without limitation, optical fiber, Long Term Evolution (LTE), 3G, WiMax, via one or more communication ports 664.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations.

Some embodiments of the present disclosure, systems and methods for managing hardware accelerator configurations in a processor chip are described. Various examples may also include a local library of accelerator programs. Specifically, in a processor chip that includes one or more programmable logic circuits, the management of downloaded hardware accelerator images may be optimized by selecting which accelerator programs are implemented in the one or more programmable logic circuits. Consequently, computing devices having more accelerator programs than available programmable logic circuits can be advantageously provided with combinations of accelerator configurations that best enhance performance and power usage of the processor chip based on a variety of criteria. Furthermore, based on historical usage of the processor chip and hardware acceleration in the processor chip, an advantageous time can be selected for reprogramming hardware acceleration in the processor chip to optimize power use and processing performance. The accelerator configurations may be selected from accelerator programs previously stored in the local library. In some examples, the accelerator programs may be stored in the library when initially downloaded for use by the processor chip.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), complex programmable logic devices (CPLDs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. In a processor having one or more programmable logic circuits, a method to implement an accelerator program in one of the one or more programmable logic circuits, the method comprising:
monitoring a use state of the processor as instructions of an application are being executed by the processor;
selecting an accelerator program stored in a library associated with the processor based on the use state of the processor; and
programming the one of the one or more programmable logic circuits with the selected accelerator program
wherein selecting the accelerator program stored in the library comprises selecting the accelerator program based on the use state of the processor comprising at least one of current time of day, current physical location of the processor, availability of external power, remaining battery charge, and power use associated with one or more applications running on the processor.

2. (canceled)

3. The method of claim 1, wherein programming the one of the one or more programmable logic circuits comprises reprogramming the programmable logic circuit with the selected accelerator program.

4. The method of claim 1, further comprising, prior to selecting the accelerator program, storing the accelerator program in the library when the accelerator program is first received by the processor.

5. The method of claim 1, further comprising:
monitoring energy usage of the one of the one or more programmable circuits in the processor when the programmable circuit is programmed with the selected accelerator program; and
recording energy usage data associated with usage of the programmable circuit when the programmable circuit is programmed with the selected accelerator program.

6. The method of claim 5, wherein recording energy usage data associated with the usage of the programmable circuit further comprises recording at least one of time of day that an application associated with the accelerator program is run by the processor, physical location of the processor when the application associated with the accelerator program is run by the processor, other accelerator programs being used in programmable logic circuits of the processor when the application associated with the accelerator program is run on the processor, other applications that run on the processor when the application associated with the accelerator program is run on the processor, duration of use for the application associated with the accelerator program, duration of use for the accelerator program, power use of the processor associated with running the application associated with the accelerator program and power use of the processor associated with programming the one of the one or more programmable logic circuits with the selected accelerator program stored in the library

7. The method of claim 5, wherein selecting the accelerator program is further based on the recorded energy usage data associated with the usage of the programmable circuit.

8. A method to program a programmable logic circuit in a processor, the method comprising:
monitoring use of a programmable logic circuit when the programmable logic circuit in the processor is programmed with a first accelerator program;
recording data associated with use of the programmable logic circuit when the programmable logic circuit is programmed with the first accelerator program;
selecting a second accelerator program based on the recorded data;
retrieving the second selected accelerator program from a library associated with the processor; and
programming the programmable logic circuit in the processor with the second accelerator program.

9. The method of claim 8, wherein selecting the second accelerator program is further based on one or more use states of the processor.

10. The method of claim 9, wherein selecting the second accelerator program based on one or more use states of the processor comprises selecting the second accelerator program based on at least one of current time of day, current physical location of the processor, availability of external power, remaining battery charge, applications currently running on the processor, current accelerator programs being used in programmable logic circuits of the processor, time elapsed since an application associated with the first accelerator program started running on the processor, time elapsed since a programmable logic circuit of the processor was programmed with the first accelerator program, a first power cost associated with running an application on the processor when a programmable logic circuit in the processor is programmed with the first accelerator program, a second power cost associated with running the application on the processor when no programmable logic circuit in the processor is programmed with the first accelerator program, a third power cost associated with running a different application on the processor when a programmable logic circuit in the processor is programmed with the second accelerator program, and a fourth power cost associated with running the different application on the processor when a programmable logic circuit in the processor is programmed with the second accelerator program.

11. The method of claim 9, further comprising storing the first accelerator program in the library when the first accelerator program is received by the processor.

12. The method of claim 11, further comprising storing the second accelerator program in the library when the second accelerator program is first received by the processor.

13. The method of claim 9, wherein the first accelerator program is associated with running a first application on the processor and the second accelerator program is associated with running a second application on the processor.

14. In a processor having one or more programmable logic circuits, a method to program a programmable logic circuit, the method comprising:
determining a first power cost associated with reprogramming one of the one or more programmable logic circuits with an accelerator program configured to run a portion of an application, and running the application with the reprogrammed logic circuit;
determining a second power cost associated with running the application without using the reprogrammed logic circuit;
comparing the first power cost to the second power cost; and
based on the comparison, programming the one of the one or more programmable logic circuits with the accelerator program configured to run the portion of the application.

15. The method of claim 14, further comprising storing the accelerator program in a library associated with the processor when the accelerator program is first received by the processor.

16. The method of claim 15, wherein programming the one of one or more programmable logic circuits comprises retrieving the accelerator program from the library.

17. The method of claim 14, wherein determining the first power cost comprises monitoring power use of the processor while running the application on the processor with the one of one or more programmable logic circuits programmed with the accelerator program.

18. A processor comprising:
one or more programmable logic circuits;
a non-volatile memory; and
a strategy module configured to:
store in the non-volatile memory one or more accelerator programs for the one or more programmable logic circuits;
monitor energy usage of the one or more programmable logic circuits; and
based on the monitored energy usage, program the one or more programmable logic circuits with the stored one or more accelerator programs.

19. The processor of claim 18, wherein the one or more programmable logic circuits comprise field-programmable gate arrays.

20. The processor of claim 18, wherein the strategy module comprises an application-specific integrated circuit or a field-programmable gate array.

21. The processor of claim 18, wherein the strategy module is configured to store in the non-volatile memory one or more accelerator programs for the one or more programmable logic circuits, upon usage of the one or more accelerator programs.

22. The processor of claim 18, wherein the strategy module is further configured to select an accelerator program from the one or more accelerator programs in the non-volatile memory based at least in part on the monitored energy usage.

23. The processor of claim 18, wherein the strategy module is further configured to identify a first programmable logic circuit from the one or more programmable logic circuits to be programmed based on the monitored energy usage.

24. The processor of claim 18, wherein the strategy module is further configured to determine a particular time to program the one or more programmable logic circuits, based at least in part on the tracked usage.

25. The processor of claim 18, wherein the strategy module is further configured to measure and store performance parameters associated with the program of the one or more programmable logic circuits.

26. The processor of claim 25, wherein the strategy module is further configured to determine a particular time to program the one or more programmable logic circuits, based on the stored performance parameters.

27. The processor of claim 25, wherein the performance parameters comprise one or more of power to program the one or more programmable logic circuits with the one or more accelerator programs; time to program the one or more programmable logic circuits with the one or more accelerator programs; and a processor reset after program of the one or more programmable logic circuits with the one or more accelerator programs.

28. In a processor having one or more programmable logic circuits and a non-volatile memory, a method to program the one or more programmable logic circuits, the method comprising:
storing in the non-volatile memory one or more accelerator programs for the one or more programmable logic circuits;
monitoring energy usage of the one or more programmable logic circuits; and
based on monitored energy usage, programming the one or more programmable logic circuits with the stored one or more accelerator programs.

29. The method of claim 28, wherein the one or more programmable logic circuits comprise a field-programmable gate array.

30. The method of claim 28, further comprising selecting an accelerator program from the one or more accelerator programs in the non-volatile memory based at least in part on the monitored energy usage.

31. The method of claim 28, further comprising selecting to be programmed a first programmable logic circuit from the one or more programmable logic circuits, based at least in part on the monitored energy usage.

32. The method of claim 28, further comprising determining a particular time to program the one or more programmable logic circuits, based at least in part on the monitored energy usage.

33. The method of claim 28, further comprising measuring and storing performance parameters associated with program of the one or more programmable logic circuits

34. The method of claim 33, wherein the performance parameters comprise one or more of power to program the one or more programmable logic circuits with the one or more accelerator programs; time to program the one or more programmable logic circuits with the one or more accelerator programs; and of a processor reset after program of the one or more programmable logic circuits with the one or more accelerator programs.

35. The method of claim 33, further comprising determining a particular time to program the one or more programmable logic circuits, based at least in part on the stored performance parameters.
